(19) United States
(12) Patent Application Publication
(10) Pub. No.: US 2023/0255132 A1
(43) Pub. Date: Aug. 17, 2023

(54) PREDICTIVE PLANTER LOOKAHEAD AND DISPLAY

(71) Applicant: Kinze Manufacturing, Inc., Williamsburg, IA (US)

(72) Inventors: Jeremy Nadke, Williamsburg, IA (US); Ryan Veatch, Williamsburg, IA (US); Matthew Moeller, Williamsburg, IA (US)

(21) Appl. No.: 18/170,670

(22) Filed: Feb. 17, 2023

Related U.S. Application Data
(60) Provisional application No. 63/268,156, filed on Feb. 17, 2022.

(51) Int. Cl. A01B 69/04; G05D 1/02

(52) U.S. Cl. CPC A01B 69/008; G05D 1/0223; G05D 1/0278; G05D 2201/0201

(57) ABSTRACT

A predictive path lookahead system is used with an agricultural vehicle and/or agricultural implement. A variety of factors relating to the vehicle and/or implement are input into the system in order to measure and process the vehicle and/or implement's motion. A navigation orientation tool is also input into the system. The system then generates a predicted lookahead trajectory and/or predicted future position of the vehicle and/or implement and can display the predicted lookahead trajectory and/or predicted future position to a user. The system can automatically turn ON and/or turn OFF a row unit or can manually alert a user when to do so based on the predicted trajectory of the implement. The system can engage in auto-steering to operate the vehicle and/or implement autonomously.

### CROSS REFERENCE TO RELATED APPLICATIONS

This application claims priority under 35 U.S.C. § 119 to provisional patent application U.S. Ser. No. 63/268,156, filed Feb. 17, 2022. The provisional patent application is herein incorporated by reference in its entirety, including without limitation, the specification, claims, and abstract, as well as any figures, tables, appendices, or drawings thereof.

### FIELD OF THE INVENTION

The invention relates generally to an apparatus, system, and/or corresponding method of use in at least the agriculture industry. More particularly, but not exclusively, the invention relates to a predictive path lookahead system and display for generating a predicted trajectory of an agricultural vehicle and/or implement. The invention also relates to automatic turn ON and/or turn OFF of a row unit of an implement based on the predicted trajectory.

### BACKGROUND OF THE INVENTION

Agricultural equipment performs a variety of functions including but not limited to planting, spraying, fertilizing, tilling, harvesting, as well as others. It is often advantageous for farming equipment to provide path planning so that a particular agricultural function, such as planting, is performed in an efficient manner. Agricultural path planning systems are often used to turn ON and/or turn OFF agricultural equipment based on the current and/or predicted path of the agricultural equipment, such as to maximize the efficient use of the full area of a field and to avoid applying a particulate, removing a crop, or otherwise compacting an area that has already been addressed by the equipment.

Existing agricultural path prediction systems lack the use of robust navigation information. Existing systems rely only on current speed and current geometry of the agricultural equipment when engaging in path planning. This results in existing agricultural path planning systems only being effective when the agricultural equipment is moving in a straight line. In situations where path prediction may be challenging, such as non-linear movement that involves curvature, existing agricultural path planning systems lack accuracy and effectiveness. Existing systems lack the ability to create a curved trajectory. Slight fluctuations of speed or geometry of the agricultural equipment may cause existing systems to prematurely turn OFF row units, which causes gaps in planting that leads to lower harvests and, therefore, hurts the farmer financially. Similarly, existing systems may prematurely turn ON row units, resulting in hurting yields by planting too many seeds in a particular area or otherwise compacting an area that has been planted or otherwise engaged by an equipment.

Existing agricultural path planning systems also lack the ability to properly display a predicted path to a farmer. Existing systems only allow path planning to be used in instances where the agricultural equipment is being driven and/or steered automatically rather than manually.

Thus, there exists a need in the art for an apparatus, method, and system which has the ability to provide, analyze, and process robust navigation information so that agricultural systems can generate a predicted trajectory in challenging circumstances such as non-linear movement. There also exists a need in the art for an apparatus, method, and system which has the ability to display a predicted trajectory of agricultural equipment to a farmer. Therefore, a farmer can utilize the path prediction and trajectory technology while manually operating the agricultural equipment, such as in the non-linear path.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

It is a further object, feature, and/or advantage of the invention to provide a system, method, and/or apparatus for a predictive path lookahead system to be used with agricultural equipment.

It is still yet a further object, feature, and/or advantage of the invention to include robust navigation information associated with agricultural equipment. This navigation information includes navigation factors that can comprise Global Positioning System (GPS) coordinates, speed, attitude, tilt, acceleration, heading, curvature, force, angular rate, orientation, trajectory steering angle, and the like.

It is still yet a further object, feature, and/or advantage of the invention to use one or more navigation sensors to monitor and measure navigation factors. The one or more navigation sensors can comprise a GPS sensor, a speed sensor, an attitude sensor, a tilt sensor such as a gyroscope, an acceleration sensor, an inertial measurement unit (IMU), one or more cameras, a steering angle sensor, and the like.

It is still yet a further object, feature, and/or advantage of the invention to include a motion model into which navigation factors can be input and then be analyzed and/or processed.

It is still yet a further object, feature, and/or advantage of the invention to generate a predicted lookahead trajectory and/or predicted future position of the agricultural equipment based on the navigation factors, input from the motion model, and a navigation orientation tool.

It is still yet a further object, feature, and/or advantage of the invention to automatically turn OFF and/or turn ON individual row units or other ground engaging elements based on the predicted lookahead trajectory and/or predicted future position.

It is still yet a further object, feature, and/or advantage of the invention to consistently provide an accurate and effective predicted lookahead trajectory and/or predicted future position even in challenging situations such as when the agricultural equipment is turning and/or is traversing a curved path.

It is still yet a further object, feature, and/or advantage of the invention to provide a display and to display or otherwise convey the predicted lookahead trajectory and/or predicted future position to a user so that a user can manually operate the agricultural equipment based on the display of the predicted lookahead trajectory and/or predicted future position.

It is still yet a further object, feature, and/or advantage of the invention to provide automatic steering capabilities so that an agricultural vehicle and/or agricultural implement can automatically follow a predicted lookahead trajectory and/or predicted future position. The disclosed system provides the ability for the agricultural vehicle and/or agricultural implement to operate autonomously.

It is still yet a further object, feature, and/or advantage of the invention to provide increased efficiency in performing an agricultural function such as planting, spraying, fertilizing, and the like. For example, by turning OFF and/or turning ON row units based on the predicted lookahead trajectory and/or predicted future position, a user can avoid both overplanting (e.g., planting too many seeds within a specified area) and underplanting (e.g., leaving gaps in a field where seed could or should have been planted). Planting is an example, but the same principle applies to other agricultural functions such as spraying, fertilizing, and the like. Overapplication and/or underapplication can both have detrimental effects on a farmer's yield, and, therefore, on a farmer's finances.

It is still yet a further object, feature, and/or advantage of the invention to reduce operator workload. By automatically turning OFF and/or turning ON row units based on the predicted lookahead trajectory and/or predicted future position, a user experiences a reduced workload as compared to if the user was operating without a predicted lookahead trajectory and/or predicted future position and had to decide himself/herself when to turn OFF and/or turn ON a row unit.

The predictive path lookahead system disclosed herein can be used in a wide variety of applications. For example, the system can be used with a variety of agricultural equipment including but not limited to agricultural implements and agricultural vehicles. Further, the disclosed system can be used in a variety of agricultural operations including but not limited to planting, fertilizing, spraying, tilling, discing, and the like.

It is preferred the apparatus be safe, cost effective, durable, and environmentally friendly. For example, some of the advantages of the system include providing efficient planting, or other agricultural function, as well as avoiding wasteful planting, or other agricultural function. While the disclosed system provides efficient turn OFF and/or turn ON of row units to avoid prematurely turning OFF a row unit resulting in gaps in planting (underplanting), the disclosed system also turns OFF row units to avoid planting too many seeds in a particular area (overplanting). By avoiding overplanting, the disclosed system is more environmentally friendly and cost effective for the farmer, since excess seed is not planted. Also, by avoiding underplanting, the disclosed system is more cost effective for the farmer, because the farmer is able to increase yields by taking full advantage of the entirety of the agricultural field.

Methods can be practiced which facilitate use, manufacture, assembly, maintenance, and repair of a system which accomplish some or all of the previously stated objectives.

The system can be incorporated into larger designs which accomplish some or all of the previously stated objectives.

According to some aspects of the present disclosure, a predictive path lookahead system for use with an agricultural implement comprises a plurality of row units, a navigation orientation tool, a navigation sensor to measure one or more navigation factors, a motion model into which the one or more navigation factors can be input, and a processing component to generate a predicted lookahead trajectory of the implement based on the navigation orientation tool and the motion model, said predicted lookahead trajectory being non-linear, wherein the system is adapted to turn ON and/or turn OFF individual row units among the plurality of row units based on the predicted lookahead trajectory of the implement.

According to at least some aspects of some embodiments disclosed, the navigation sensor comprises a GPS sensor and/or GPS receiver, a speed sensor, an attitude sensor, a tilt sensor, an acceleration sensor, an inertial measurement unit (IMU), one or more cameras, and/or a steering angle sensor.

According to at least some aspects of some embodiments disclosed, the one or more navigation factors comprises GPS coordinates of the implement, speed of the implement, attitude of the implement, tilt of the implement, acceleration of the implement, heading of the implement, curvature, force, angular rate of the implement, orientation of the implement, trajectory of the implement, and/or steering angle of the implement.

According to at least some aspects of some embodiments disclosed, the navigation factors are continuously monitored.

According to at least some aspects of some embodiments disclosed, the system further comprises a display in which the predicted lookahead trajectory of the implement can be displayed to a user.

According to at least some aspects of some embodiments disclosed, each individual row unit is automatically turned ON and/or OFF.

According to at least some aspects of some embodiments disclosed, the system alerts a user when to manually turn ON and/or turn OFF a row unit.

According to at least some aspects of some embodiments disclosed, the navigation orientation tool is a map of agricultural terrain and/or an automated guidance tool.

According to at least some aspects of some embodiments disclosed, the system is adapted to automatically steer the implement based on the predicted lookahead trajectory such that the implement can operate autonomously.

According to at least some aspects of some embodiments disclosed, the motion model processes the one or more navigation factors.

According to at least some aspects of some embodiments disclosed, a method of predicting the future trajectory of an agricultural implement comprises determining one or more navigation factors related to the agricultural implement, inputting the one or more navigation factors into a motion model, generating a non-linear predicted lookahead trajectory of the implement via navigation orientation information and the motion model, and turning ON and/or turning OFF a row unit of the implement based on the non-linear predicted lookahead trajectory of the implement.

According to at least some aspects of some embodiments disclosed, the one or more navigation factors comprise GPS coordinates of the implement, speed of the implement, attitude of the implement, tilt of the implement, acceleration of the implement, heading of the implement, curvature of the implement, force of the implement, angular rate of the implement, orientation of the implement, trajectory of the implement, and/or steering angle of the implement.

According to at least some aspects of some embodiments disclosed, the navigation orientation information is based on a map of agricultural terrain and/or an automated guidance tool.

According to at least some aspects of some embodiments disclosed, the method further comprises displaying the non-linear predicted lookahead trajectory to a user.

According to at least some aspects of some embodiments disclosed, the row unit is turned ON and/or turned OFF automatically.

According to at least some aspects of some embodiments disclosed, the method further comprises alerting a user when to manually turn ON and/or turn OFF the row unit.

According to at least some aspects of some embodiments disclosed, the one or more navigation factors are determined by a navigation sensor that comprises a GPS sensor and/or GPS receiver, a speed sensor, an attitude sensor, a tilt sensor, an acceleration sensor, an inertial measurement unit (IMU), one or more cameras, and/or a steering angle sensor.

According to at least some aspects of some embodiments disclosed, the one or more navigation factors related to the implement are continuously monitored.

According to at least some aspects of some embodiments disclosed, the non-linear predicted lookahead trajectory may be generated via a Kalman filter.

According to at least some aspects of some embodiments disclosed, a predictive path lookahead system for use with an agricultural implement comprises a row unit, a navigation orientation tool, a navigation sensor to measure a navigation factor, a motion model into which the navigation factor can be input, and a processing component to generate a predicted future position of the implement based on the navigation orientation tool and the motion model, wherein the system is adapted to turn ON and/or turn OFF the row unit based on the predicted future position of the implement.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 shows a perspective view of an exemplary agricultural planting implement.

FIG. 2 is a front elevation view of the agricultural planting implement.

FIG. 3 shows a is a side elevation view of the agricultural planting implement.

FIG. 4 is a perspective view of an exemplary agricultural vehicle.

FIG. 5 is a perspective view of an exemplary row unit to be used with an agricultural implement.

FIG. 6 is a side elevation view of the row unit.

FIG. 7 is a block diagram of components of a predictive path lookahead system according to some aspects of the disclosure.

FIG. 8 is a flow diagram of a predictive path lookahead method according to some aspects of the disclosure.

FIG. 9 is an overhead view illustrating an example of use of a predictive path lookahead system according to some aspects of the disclosure.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described and/or envisioned based upon that disclosed in the present specification and the figures.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

The term “agricultural equipment” encompasses any type of machinery associated with the agriculture industry. For example, both agricultural vehicles and agricultural implements are encompassed by the term “agricultural equipment”.

The term “particulate material” shall be construed to have a broad meaning, and includes, but is not limited to grain, seed, fertilizer, insecticide, dust, pollen, rock, gravel, dirt, stock, or some combination thereof. Particulate material can be mixed with air to form airborne matter.

The terms “predicted lookahead trajectory”, “predicted trajectory”, and “predicted future position” can be used interchangeably throughout the description.

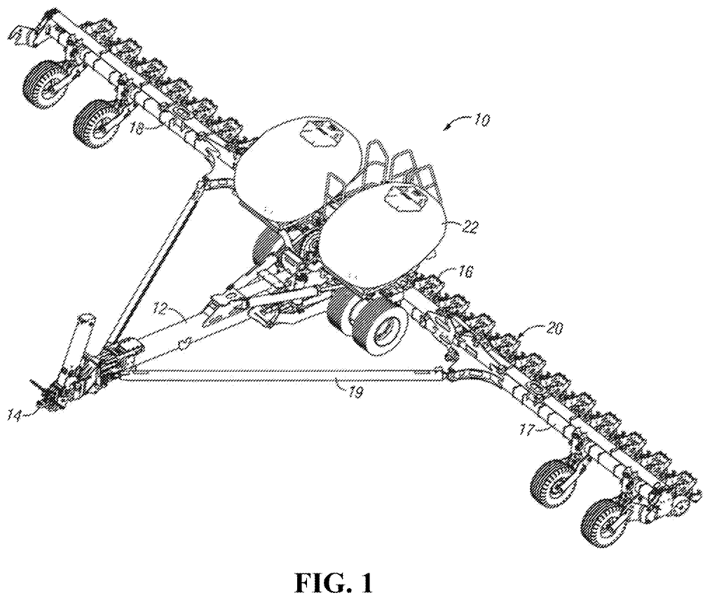

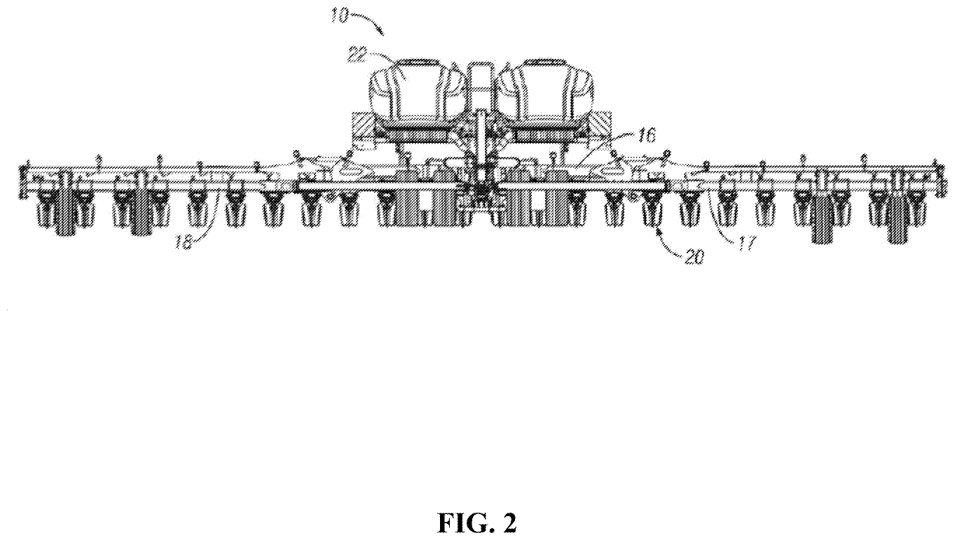

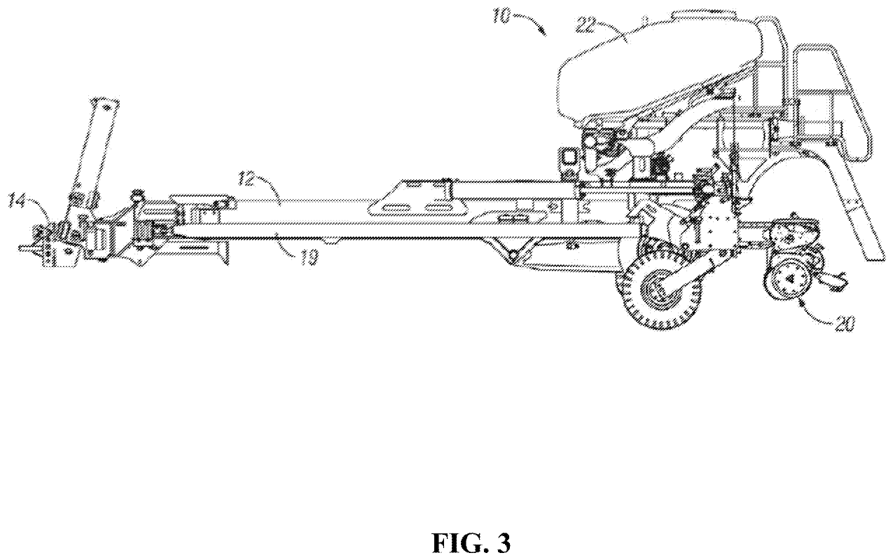

FIGS. 1-3 disclose an exemplary agricultural implement 10. The agricultural implement 10 as shown in the figures is a planting implement 10. The predictive path lookahead system disclosed herein can be used in conjunction with an agricultural planter such as the exemplary planter depicted in FIGS. 1-3. Although the implement shown in FIGS. 1-3 is a planting implement, the predictive path lookahead system, apparatus, and/or methods as shown and/or described herein can be used with agricultural implements other than planting implements, such as but not limited to, sprayers, fertilizers spreaders, tillage equipment, plows, discs, and the like. Additionally, the predictive path lookahead system, apparatus, and/or methods may be used on self-propelled agricultural equipment (i.e., an unmanned or otherwise autonomous vehicle/implement), such as that disclosed in U.S. Pat. No. 10,104,824, which is hereby incorporated by reference in its entirety. The implement 10 may be generally any implement for engaging with the ground or otherwise distributing a material, such as a particulate or liquid material to the ground. As will be understood, the implement includes ways to distribute material, such as a particulate material to various ground engaging apparatus to distribute said particulate material accurately, efficiently, with increased control, and in some embodiments, at high speed to distribute said particulate material to or in said ground. Furthermore, as will be understood, while the planting implement 10 as shown in the figures is provided, additional types of implements including additional planting implements with various features as is known can utilize the invention and/or aspects thereof to be able to distribute and apply the particulate material such as seed or other dry particulate, or a liquid material such as liquid fertilizer, to the ground.

The planting implement 10 as shown in the FIGS. 1-3 includes a tongue 12 with a hitch 14 at a first end and a tool bar 16 extending generally transversely to the tongue 12 at a second end. The tool bar 16 extends to connect to a plurality of row units 20, which include ground engagement apparatus. The row units 20 may also include additional aspects such as metering elements, singulation elements, ground opening and/or closing elements, metering system, sensors, motors, and the like. However, it is to be appreciated that generally other types of row units, ground engaging elements, and/or metering elements can utilize any of the aspects of the invention disclosed herein. For example, the row units 20 could include fertilizer or other particulate and/or liquid material application apparatus, and the entrainment system disclosed be used to distribute the particulate and/or liquid material to the row units 20.

Extending outwardly from the toolbar 16 and being generally an extension thereof are wing elements 17 and 18. The wing elements 17, 18 provide additional width of the toolbar such that additional row units 20 can be attached along thereto. This allows for a greater number of row units 20 to be attached to the toolbar to be used for distributing a particulate material and/or liquid fertilizer. Additional elements shown in the figures include draft links 19, which generally connect the wings 17, 18 to the tongue 12. One or more actuators can be connected to the system to provide for the wings 17, 18 to be folded in a generally forward manner wherein they will be somewhat parallel to the tongue 12 to move the planting implement 10 from a field use configuration to a row use configuration. However, additional planting units may include that the toolbar is lifted and rotated, is folded rearwardly, is folded vertically, does not fold at all, or includes some sort of combination thereof.

Agricultural planting implements, such as the exemplary one shown in FIGS. 1-3, are used to distribute, meter, and place particulate materials, such as seed, in operable and/or desired locations in a field. This is based, in part, on agronomical data, which is used to determine the optimal spacing, depth, and location of seed to give the seed the best chance to mature into a crop with the best possible yield. The exemplary agricultural implement 10 of FIGS. 1-3 includes central hoppers 22, wherein the central hoppers 22 may store particulate materials, such as seed, and/or liquid materials, such as liquid fertilizer, to be applied to an agricultural field. The exemplary agricultural implement 10 of FIGS. 1-3 may also apply liquid material, such as liquid fertilizer, to an agricultural field.

To further aid in increasing the performance and growing of crop from a planted seed, implements can include systems and other apparatus that are used to apply, place, or otherwise dispense a fertilizer, such as a liquid or dry fertilizer material. For agricultural planting implements, a fertilizer applicator/distribution system, such as the system disclosed in U.S. Patent Application No. 63/261,973, filed Oct. 1, 2021, which is hereby incorporated in its entirety, can be included with the row units of the planter, or with the implement as a whole. This will provide the application of the fertilizer contemporaneously, or near-contemporaneously, with the planting of the seed. However, it should be appreciated that, if the implement is an applicator only, such as a sprayer, the system can continually provide needed liquid fertilizer on an as-needed basis. The system can include one or more hoppers/tanks, either at the bulk hopper site, at the individual row units, or split out to cover regions or sections of row units, wherein the application sites will be fed an amount of the liquid fertilizer.

A predictive path lookahead system, such as shown and described herein, can be included as part of an agricultural implement such as that depicted in FIGS. 1-3 or as part of a liquid fertilizer application/distribution system such as disclosed in U.S. Patent Application No. 63/261,973 to provide a predictive lookahead trajectory and/or predicted future position and to turn OFF and/or turn ON individual rows and/or row units based on the predicted trajectory and/or position. A predictive path lookahead system, such as shown and described herein, can be applied to planting, fertilizing, spraying, and the like.

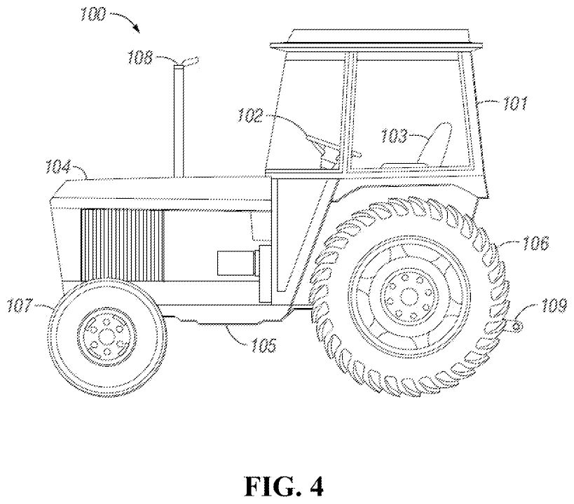

FIG. 4 discloses an exemplary agricultural vehicle 100 (e.g., a tractor) used for the purposes of towing machinery used in agriculture (e.g., agricultural implements). Accordingly, the vehicle may be referred to as a prime mover, tow vehicle, or the like. In some aspects, the agricultural vehicle 100 may be used to tow an agricultural implement such as the agricultural implement 10 depicted in FIGS. 1-3. The agricultural vehicle 100 may include a cab 101 with a steering wheel 102 and a seat 103 for an operator. The agricultural vehicle 100 may also include a vehicle frame 104 which houses an engine located near the front axle of the agricultural vehicle 100 and in front of the cab 101. The cab 101 and vehicle frame 104 may be supported, structurally, by the agricultural vehicle's chassis 105, which attaches to rear drivable wheels 106 and front steerable wheels 107, said front steerable wheels 107 operationally connected to the steering wheel 102. An exhaust pipe 108 allows carbon monoxide to exit the agricultural vehicle 100 during operation of the engine. A vehicle hitch 109 allows for connection between agricultural machinery, such as agricultural implements, and the agricultural vehicle 100.

In some aspects, the agricultural vehicle 100 shown in FIG. 4 could be used to tow the agricultural implement 10 shown in FIGS. 1-3. As mentioned, a predictive path lookahead system, as shown and described herein, could be included on an agricultural vehicle and/or agricultural implement.

It is also envisioned that the agricultural vehicle 100 could be an autonomous or unmanned vehicle, such as that disclosed in U.S. Pat. No. 10,104,824, which is hereby incorporated by reference in its entirety.

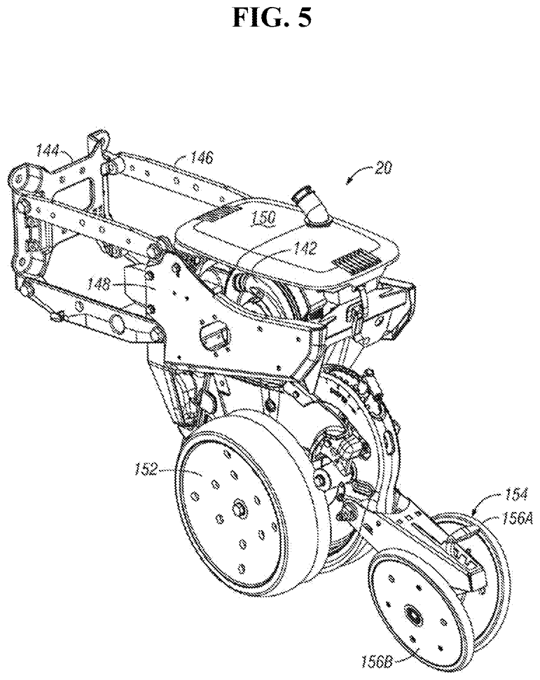

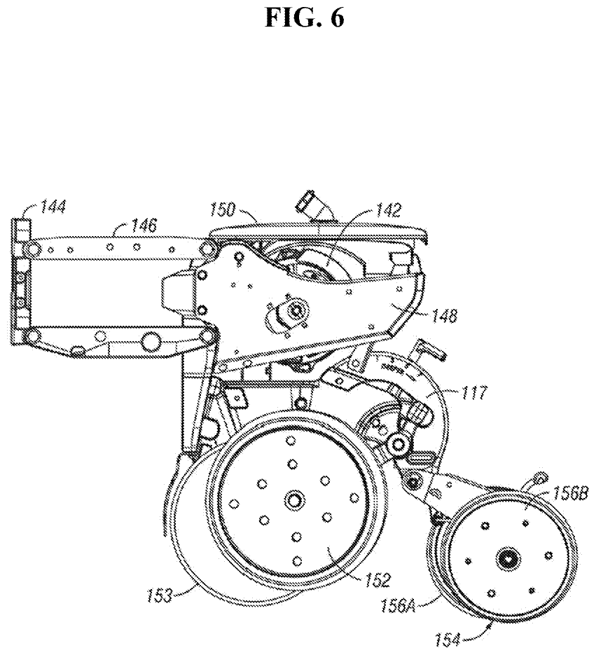

FIGS. 5 and 6 disclose an exemplary row unit of the plurality of row units 20, included as part of the implement 10, extending from the wings 17, 18 and the toolbar 16. A planter row unit 20 with an air seed meter 142 positioned therewith is shown in FIGS. 5 and 6. For example, the seed meter 142 may utilize a negative or positive air pressure to retain and transport seed about one or more seed discs within the seed meter housing. The row unit 20 and air seed meter 142 may be of the kind shown and described in U.S. Pat. No. 9,282,691, which is hereby incorporated in its entirety. However, it should be appreciated that aspects of embodiments of the present disclosure contemplate other types of seed meters, including mechanical, brush, finger, or the like, which may be used with the invention. In addition, the seed meter may be a multi-hybrid seed meter that is capable of dispensing one of a plurality of types, varieties, hybrids, etc. of seed at a row unit, such as by the use of multiple seed discs within the seed meter housing. In addition, when the implement 10 is not a planting implement, the row units may take other forms, such as those for engaging with the ground associated with the particular type of implement (e.g., tillage equipment or the like).

The row unit 20 includes a U-bolt mount (not shown) for mounting the row unit 20 to the planter frame or tool bar 16 (on central frame and wings 17, 18), as it is sometimes called, which may be a steel tube of 5 by 7 inches (although other sizes are used). However, other mounting structures could be used in place of the U-bolt. The mount includes a face plate 144, which is used to mount left and right parallel linkages 146. Each linkage may be a four bar linkage, as is shown in the figures. The double linkage is sometimes described as having upper parallel links and lower parallel links, and the rear ends of the parallel links are pivotally mounted to the frame 148 of the row unit 20. The frame 148 includes a support for the air seed meter 142 and seed hopper 150, as well as a structure including a shank 117 for mounting a pair of ground-engaging gauge wheels 152. The frame 148 is also mounted to a closing unit 154, which includes a pair of inclined closing wheels 156A, 156B. The row unit 20 also includes a pair of opener discs 153. While the row unit 20 shown in FIGS. 5 and 6 is configured to be used with a bulk fill seed system, it is to be appreciated that the row unit 20 may have one or more seed hoppers 150 at each of the row units 20. Exemplary versions of row units with individual hoppers are shown and described in U.S. Pat. No. 9,420,739, which is hereby incorporated in its entirety. In addition, a high speed planting implement, such as that disclosed in U.S. Pat. No. 10,842,072, which is hereby incorporated in its entirety, could be utilized with any of the aspects of any embodiments disclosed herein.

The implement 10 and row units 20 shown and described in FIGS. 5 and 6 include an air seed meter 142 for singulating and transporting seed or other particulate material from the seed delivery source to the created furrow in the field prior to the closing wheels 156A, 156B closing said furrow.

Still further, it should be appreciated that a predictive path lookahead system as disclosed herein could be used with other types of agricultural implements in addition to planters, including but not limited to, sprayers, fertilizers, tillage equipment, plows, discs, and the like. The system can be configured to work with generally any type of implement to be able to generate a predicted lookahead trajectory and/or predicted future position of the implement and turn OFF and/or turn ON a row and/or row unit of the implement as the implement travels through an agricultural field.

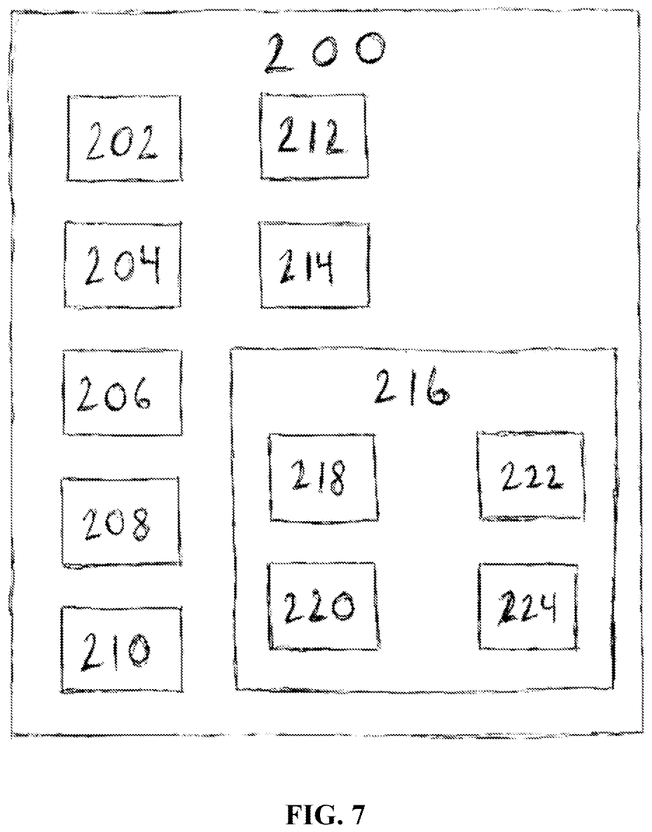

FIG. 7 shows a block diagram of an exemplary embodiment of a predictive path lookahead system 200 according to some aspects and/or embodiments of the present disclosure. The predictive path lookahead system 200 may be used in conjunction with agricultural equipment such as an agricultural vehicle and/or agricultural implement. For example, the predictive path lookahead system 200 could be used in conjunction with the exemplary agricultural vehicle 100 shown in FIG. 4 and/or with the exemplary agricultural implement 10 shown in FIGS. 1-3. The exemplary embodiment of the predictive path lookahead system 200 as depicted in FIG. 7 includes a navigation orientation tool 202, a navigation sensor 204, one or more navigation factors 206, a motion model 208, a processing component 210, a display 212, a row unit 214, and an intelligent implement control system 216 comprising an intelligent planter router/intelligent implement router (IPR/IIR) 218, an intelligent planter node/intelligent implement node (IPN/IIN) 220, an intelligent planter positioning/intelligent implement positioning (IPP/IIP) 222, and an intelligent implement display 224. The depiction shown in FIG. 7 includes one navigation orientation tool 202, however more than one can be included. The depiction in FIG. 7 includes one navigation sensor 204, however, the number of navigation sensors included may number from 1 to N where N is any number greater than 1. The row unit 214 may be any type of agricultural row unit, such as the exemplary row unit shown in FIGS. 5 and 6. The depiction shown in FIG. 7 includes only one row unit 214, but any number of row units can be included.

The predictive path lookahead system 200 depicted in FIG. 7 includes a navigation orientation tool 202. The navigation orientation tool 202 may be a map, an automated guidance tool, or any other kind of tool that provides navigational and/or spatial orientation.

The map can be a map of agricultural terrain, which may indicate which portions of the terrain are planted versus unplanted. The map could be integrated from a third party source, or could be generated by the system. In addition, the map could be satellite based, terrain based, topography based, or the like. The automated guidance tool may be any standard off-the-shelf guidance tool used in any type of vehicle industry including but not limited to agriculture, automobile, freight, aeronautics, aerospace, train, boating, and the like.

The navigation orientation tool 202 provides location positioning of the agricultural vehicle and/or agricultural implement in relation to the location of agricultural terrain, specific areas of agricultural terrain, landmarks, GPS coordinates, objects, geographic locations, and the like. As mentioned above, the navigation orientation tool 202 can provide a roadmap of planted and/or unplanted portions of an agricultural field. This can include historical data of previously planted portions of the agricultural field. Therefore, the predictive path lookahead system 200 can use the information provided by the navigation orientation tool 202 when generating a predicted lookahead trajectory and/or predicted future position and when automatically turning OFF and/or turning ON individual rows and/or row units of an agricultural implement or manually alerting a user to do so. The navigation orientation tool can also be used to help with auto-steering of the agricultural vehicle and/or agricultural implement when the agricultural vehicle and/or agricultural implement is operating autonomously.

The predictive path lookahead system 200 depicted in FIG. 7 is adapted to measure, monitor, gather, collect, and/or determine a variety of navigation factors 206. The one or more navigation sensors 204 are used to measure, monitor, gather, collect, and/or determine the one or more navigation factors 206. The one or more navigation factors 206 may include but are not limited to GPS coordinates, speed, attitude, tilt, acceleration, heading, curvature, force, angular rate, orientation, trajectory, and/or steering angle. The navigation factors 206 can be associated with any type of agricultural equipment, including an agricultural vehicle and/or agricultural implement. In addition, the navigation sensor(s) could be positioned at the agricultural vehicle, the agricultural implement, or at both.

A navigation sensor 204 is included in the predictive path lookahead system 200 depicted in FIG. 7. The system 200 may include one or more navigation sensors 204. The navigation sensor 204 may include but is not limited to a GPS sensor and/or GPS receiver, a speed sensor, an attitude sensor, a tilt sensor, an acceleration sensor, an inertial measurement unit (IMU), one or more cameras, and/or a steering angle sensor.

According to some aspects of the disclosure, the navigation sensor 204 can generally be placed on and/or near the agricultural vehicle and/or agricultural implement and can include various sensors to provide information to a motion model 208. The one or more navigation sensors 204 can additionally include vision sensors, radar sensors, LIDAR sensors, heat sensors, moisture content sensors, radio frequency sensors, short-range radio, long-range radio, antennas, and the like. These sensors can be grouped in any manner and can be used to determine many aspects. For example, the sensors can be used to determine the location of a nearby object or obstruction. The sensors may be used to determine soil characteristics, such as moisture content, compaction, temperature, and the like. The sensors can also be location sensors to determine if the agricultural vehicle and/or agricultural implement is on level ground, on a hill, going up or down hill, turning, and the like. The sensors could also be used with other location determining systems, such as GPS. The combination of the sensors and location determination systems would allow an agricultural vehicle and/or agricultural implement to travel to a location without running into obstructions, without running into other agricultural equipment, without damaging planted or existing crops, as well as with obeying other rules, such as traffic regulations. The sensors and/or location determining systems would allow an agricultural vehicle and/or agricultural implement to travel from one location to another, to locations within a field, or otherwise in combination with additional vehicles safely and precisely.

According to some aspects of the disclosure, the navigation sensors 204 sense one or more characteristics of an object and can further include, for example, accelerometers, position sensors, pressure sensors (including weight sensors), and/or fluid level sensors among many others. The accelerometers can sense acceleration of an object in a variety of directions (e.g., an x-direction, a y-direction, etc.). The position sensors can sense the position of one or more components of an object. For example, the position sensors can sense the position of an object relative to another fixed object such as a wall. Pressure sensors can sense the pressure of a gas or a liquid or even the weight of an object. The fluid level sensors can sense a measurement of fluid contained in a container or the depth of a fluid in its natural form such as water in a river or a lake. Fewer or more sensors can be provided as desired. For example, a rotational sensor can be used to detect speed(s) of object(s), a photodetector can be used to detect light or other electromagnetic radiation, a distance sensor can be used to detect the distance an object has traveled, a timer can be used for detecting a length of time an object has been used and/or the length of time any component has been used, and a temperature sensor can be used to detect the temperature of an object or fluid.

In some embodiments, a satellite-based radio-navigation system such as the global positioning system (“GPS”) is used. GPS uses satellites to provide geolocation information to a GPS receiver. GPS, and other satellite-based radio-navigation systems, can be used for location positioning, navigation, tracking, and mapping. A standard off-the-shelf GPS sensor and/or GPS receiver may be used by the system 200 for location positioning, navigation, tracking, and/or mapping of the agricultural vehicle and/or agricultural implement.

The navigation sensor 204 may include any kind of speed sensor such as any standard off-the-shelf speedometer. The speed sensor may be any type of standard speed sensor used in any type of vehicle industry including but not limited to agriculture, automobile, freight, aeronautics, aerospace, train, boating, and the like.

The navigation sensor 204 may include any kind of attitude sensor such as any standard off-the-shelf attitude sensor. The attitude sensor may be any type of standard attitude sensor used in any type of vehicle industry including but not limited to agriculture, automobile, freight, aeronautics, aerospace, train, boating, and the like.

The navigation sensor 204 may include any kind of tilt sensor. The tilt sensor may be any standard off-the-shelf tilt sensor such as a gyroscope. The tilt sensor may be any type of standard tilt sensor used in any type of vehicle industry including but not limited to agriculture, automobile, freight, aeronautics, aerospace, train, boating, and the like.

The navigation sensor 204 may include any kind of acceleration sensor such as any standard off-the-shelf accelerometer. The acceleration sensor may be any type of standard acceleration sensor used in any type of vehicle industry including but not limited to agriculture, automobile, freight, aeronautics, aerospace, train, boating, and the like.

The navigation sensor 204 may include any kind of inertial measurement unit (IMU) to measure navigation factors 206 including but not limited to heading, force, angular rate, orientation, curvature, and the like. The IMU may comprise any combination of accelerometers, gyroscopes, and/or magnetometers. IMUs are commonly used in the aeronautics and aerospace industries. The IMU used by the system 200 can be any IMU used in any type of vehicle industry including but not limited to agriculture, automobile, freight, aeronautics, aerospace, train, boating, and the like.

The navigation sensor 204 may include any combination of cameras such as any standard off-the-shelf camera capable of taking still images and/or videos. The one or more cameras can comprise one or more infrared (IR) cameras. The combination of cameras may be any type of standard camera used in any type of vehicle industry including but not limited to agriculture, automobile, freight, aeronautics, aerospace, train, boating, and the like.

The navigation sensor 204 may include any kind of steering angle sensor such as any standard off-the-shelf steering angle sensor. The steering angle sensor may be any type of standard steering angle sensor used in any type of vehicle industry including but not limited to agriculture, automobile, freight, aeronautics, aerospace, train, boating, and the like.

The navigation sensors 204 measure, monitor, gather, collect, and determine the one or more navigation factors 206 associated with the agricultural vehicle and/or agricultural implement. The one or more navigation factors 206 are then input into the motion model 208. The navigation factors 206 can be continuously monitored, measured, gathered, collected, and determined throughout the use of an agricultural vehicle and/or agricultural implement, and the navigation factors 206 can be continuously input into the motion model 208.

The motion model 208 analyzes, processes, organizes, and/or aggregates the navigation factors 206 that are input into the motion model 208. The motion model 208 creates an accurate determination of the current position of the agricultural vehicle and/or agricultural implement and the current nature of the agricultural vehicle's and/or agricultural implement's motion. The motion model 208 and/or the system 200 in general can also use a prediction and/or estimation algorithm to estimate a predicted future position and/or trajectory of the agricultural vehicle and/or implement based on the navigation factors 206 input into the motion model 208. The motion model 208 may also use, analyze, organize, aggregate, and/or process physical factors associated with the agricultural vehicle and/or agricultural implement including but not limited to its size, mass, weight, height, tire size, and the like. The motion model 208 may also use, analyze, organize, aggregate, and/or process other factors associated with environmental conditions including but not limited to ambient temperature, humidity, moisture level of the soil in the agricultural field, wind, precipitation, and the like. All factors can be continuously input into the motion model 208 during operation of the agricultural vehicle and/or agricultural implement. Similarly, the motion model 208 can be continuously analyzing and processing the data and factors input into it. Additionally, feedback and/or field data related to completed paths of the agricultural vehicle and/or implement and related to which portions of a field have already been planted may be continuously input into the motion model 208 during planting such that the motion model 208 can analyze, process, organize, and/or aggregate that data and input that data into a prediction and/or estimation algorithm in real time to continuously update and improve its predicted future position and/or trajectory of the agricultural vehicle and/or implement. The prediction and/or estimation algorithm can blend all data, such as navigation factors 206, physical factors, environmental factors, and/or feedback and/or field data when predicting a future position and/or trajectory of the agricultural vehicle and/or implement. The prediction and/or estimation algorithm used by the motion model 208 and/or the system 200 in general can be a Kalman filter and/or another algorithm that uses aspects of Kalman filtering such as using measurements observed over time. The motion model 208 can produce an output of processed and/or raw data that reflects the position of the agricultural vehicle and/or agricultural implement and the nature of the agricultural vehicle's and/or agricultural implement's motion. The prediction and/or estimation algorithm, such as a Kalman filter, can generate and output a predicted future position and/or trajectory of an agricultural vehicle and/or implement based on the data and/or factors input into the motion model as well as other data and/or factors. The data and/or factors input into the motion model 208 can be extrapolated and, thus, utilized to predict a predicted future position and/or trajectory of an agricultural vehicle and/or implement.

The predictive path lookahead system 200 depicted in FIG. 7 includes a processing component 210. The motion model 208 can be included as part of the processing component 210. The motion model 208 can be performed, executed, and/or implemented via the processing component 210. The processing component 210 may be any type of controller, microcontroller, computer processor, electronic processor, and the like. The processing component 210 may include memory.

The processing component 210 uses a prediction and/or estimation algorithm to generate a predicted lookahead trajectory and/or predicted future position of an agricultural vehicle and/or agricultural implement. The processing component uses any combination of the navigation factors 206, the physical factors associated with the agricultural vehicle and/or agricultural implement, environmental factors, data from the motion model, feedback and/or field data such as that related to which portions of the field have been planted and completed paths planted by the agricultural vehicle and/or agricultural implement, and/or data provided by the navigation orientation tool as input data that is input into the prediction and/or estimation algorithm to generate the predicted trajectory and/or predicted future position of the agricultural vehicle and/or agricultural implement. The processing component 210 analyzes and processes the data input into it to generate the predicted trajectory and/or predicted future position. The processing model 210 can continuously be processing data and continuously generating an improved predicted lookahead trajectory and/or predicted future position during operation of the agricultural equipment. The processing component 210 can apply an algorithm and/or other mathematical formulae to the input data to generate a predicted lookahead trajectory and/or predicted future position.

For example, the processing component 210 can use, as at least part of its prediction and/or estimation algorithm, a Kalman filter and/or use aspects of Kalman filtering when processing data and generating a predicted trajectory and/or a predicted future position of the agricultural equipment. The Kalman filter can utilize and/or blend all factors including but not limited to the navigation factors 206, the physical factors associated with the agricultural equipment, environmental factors, processed data from the motion model 208, feedback and/or field data, and/or data from the navigation orientation tool. The processing unit 210 can also utilize calculation techniques using mathematical formulae and/or principles such as geometry and/or calculus principles to generate a predicted lookahead trajectory and/or future position of the agricultural equipment. The processing unit 210 can also store and analyze past data related to generation of past lookahead trajectories and/or predicted positions as well as information related to turning a row unit ON and/or OFF based on past lookahead trajectories and/or predicted positions. The processing unit 210 can gauge how successful past predicted lookahead trajectories and/or predicted future positions were in avoiding overplanting and/or underplanting, and the processing unit 210 can learn from that past data. In this way, the processing unit 210 can apply an artificial intelligence (AI) and/or machine learning model to past and present data to continually improve the effectiveness and efficiency of the predictive path lookahead system 200. Additionally, any type of historical data, such as historical planting data, and/or mathematical formulae can be input into the prediction/estimation algorithm.

By using such a robust motion model 208 that includes a wide variety of navigation factors 206, and by using a powerful prediction/estimation technique, the predictive path lookahead system 200 is able to provide an accurate and effective predicted lookahead trajectory even in non-linear movement situations such as when the agricultural equipment is turning or will experience future curvature. For example, by continuously monitoring and using the multitude of navigation factors 206, by continuously utilizing the orientation navigation tool 202, and by continuously applying the estimation and/or prediction algorithm, the system 200 is able to generate an accurate predicted lookahead trajectory and/or predicted future position even around curves, on hills, and other challenging situations.

Some embodiments of the predictive path lookahead system 200 include a processing component 210 (e.g., a controller), which can be used to establish communications, and/or other components for establishing communications. Examples of such a processing component 210 may be processing units alone or other subcomponents of computing devices. The processing component 210 can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory of the processing component 210 can include, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Memory associated with the processing component 210 can store data related to agricultural terrain, agricultural functions, historical data, agricultural equipment, navigation factors, environmental factors, past planting data, feedback and/or field data, and the like. The memory can store data related to portions of an agricultural field that are planted versus unplanted, sprayed versus unsprayed, fertilized versus unfertilized, plowed versus unplowed, and/or historical data related to any type of agricultural function. By storing historical data, the processing component 210 can better generate a predicted lookahead trajectory and can better determine when to turn OFF and/or turn ON the rows and/or row units of an agricultural implement.

The predictive path lookahead system 200 can communicate with the individual rows and/or row units of an agricultural implement to automatically turn ON and/or turn OFF row units based on the predicted lookahead trajectory and/or predicted future position as well as other factors such as which portions of an agricultural field are planted versus unplanted. Communication can be performed via the processing component 210 or by other means. When an agricultural implement is traversing an area of the agricultural field that is unplanted or is predicted to traverse an unplanted area based on the predicted lookahead trajectory and/or predicted future position, the system 200 can communicate with one or more row units 214 to automatically turn ON the one or more row units 214 to plant seed in that area if it is desired for that area to be planted. Thus, by being able to accurately predict the trajectory of the agricultural implement, the system avoids underplanting by planting an unplanted area. When an agricultural implement is traversing an area of the agricultural field that is already planted or is predicted to traverse an already-planted area based on the predicted lookahead trajectory and/or predicted future position, the system 200 can communicate with one or more row units 214 to automatically turn OFF the one or more row units 214 to prevent seed from being planted in that area. The system 200 can also communicate with the one or more row units 214 to turn OFF row units to avoid planting too close to an already-planted area, which can be another form of overplanting. Thus, by being able to accurately predict the lookahead trajectory and/or future position of the agricultural vehicle and/or agricultural implement, the system avoids overplanting by preventing additional seed to be planted in or too close to an already-planted area. The one or more row units 214 can also be turned ON and/or turned OFF manually by a user.

The system 200 depicted in FIG. 7 is also adapted to engage in automatic steering (auto-steering) of the agricultural vehicle and/or agricultural implement wherein the agricultural vehicle and/or agricultural implement can operate completely autonomously. Once the predicted lookahead trajectory and/or predicted future position is generated, the system 200 can engage in auto-steering of the agricultural vehicle and/or agricultural implement to ensure that it maintains and follows the predicted lookahead trajectory and/or predicted future position. The auto-steering feature is adapted to function effectively even in challenging situations such as when the agricultural vehicle and/or agricultural implement is traveling along a non-linear path that includes some amount of curvature. The system 200 is adapted to continuously monitor and determine the navigation factors 206 associated with the agricultural vehicle and/or agricultural implement in conjunction with continuously monitoring the navigation orientation tool 202 and output from the motion model 208 to ensure that the agricultural vehicle and/or agricultural implement is following the predicted lookahead trajectory and/or predicted future position. The system 200 is adapted to continuously correct the agricultural vehicle and/or agricultural implement via auto-steering should it deviate from the predicted lookahead trajectory and/or predicted future position. While all navigation factors 206 are relevant, some of the key factors 206 when the system 200 is engaging in auto-steering, especially when curvature is involved, are the GPS coordinates as well as input from the one or more cameras and LIDAR to sense what area of the field the agricultural vehicle and/or agricultural implement is in or near (planted versus unplanted) and/or if obstacles, objects, and/or curvature are in the vehicle's and/or implement's path.

Different embodiments of the system 200 are adapted to provide a variety of communication techniques between the system 200 and an agricultural implement and/or an individual row unit 214. These communication techniques include but are not limited to communication via network connection, ISOBUS, Ethernet, the Internet Protocol (IP), and the Transmission Control Protocol (TCP), as well as other transmission/communication protocols.

In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

ISO 11783, known as Tractors and machinery for agriculture and forestry—Serial control and communications data network (commonly referred to as “ISO Bus” or “ISOBUS”) is a communication protocol for the agriculture industry based on the SAE J1939 protocol (which includes CAN bus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group/collection of IEEE standards produced by the working group defining the physical layer and data link layer's media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (“VoIP”). Websites can use TLS to secure all communications between their servers and web browsers.

In some embodiments, a device could include one or more communications ports such as Ethernet, serial advanced technology attachment (“SATA”), universal serial bus (“USB”), or integrated drive electronics (“IDE”), for transferring, receiving, or storing data.

The exemplary embodiment of the system 200 depicted in FIG. 7 also includes a display 212. The display 212 can display to a user the predicted lookahead trajectory and/or predicted future position of agricultural equipment. A user can use the displayed trajectory and/or future position of the agricultural equipment when manually operating the agricultural equipment. The display can convey information to the user regarding the locations where row units should be turned ON and/or turned OFF so that the user can manually turn ON and/or turn OFF particular row units if the user should choose to do so manually rather than allow the system 200 to do so automatically. During manual operation, the display 212 can provide an alert to a user that alerts the user as to when to turn ON and/or turn OFF particular row units to avoid overplanting or underplanting. The alerts can be visual, auditory, and/or any other suitable method of conveying information to a user. The display 212 can also indicate to the user when the user is deviating from the predicted trajectory and/or predicted future position and can alert the user to correct the user's steering and/or can offer steering suggestions to the user.

The display 212 may be a digital interface, a command-line interface, a graphical user interface (“GUI”), oral interface, virtual reality interface, or any other way a user can interact with a machine (user-machine interface). For example, the display 212 can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the display can then be sent to a microcontroller to control operational aspects of a device.

The display 212 can act as an input and/or output device. More particularly, the display 212 can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The display 212 also can be configured with a microcontroller to display conditions or data associated with the main device in real-time or substantially real-time.

The exemplary embodiment of the system 200 depicted in FIG. 7 also includes an intelligent implement control system 216 which comprises an IPR 218, an IPN 220, an IPP 222, and an intelligent implement display 224. The implement control system 216, including an IPR 218, IPN 220, IPP 222, and an intelligent implement display 224, may be that which is disclosed in U.S. Pat. No. 10,952,365 which is hereby incorporated in its entirety. All child US Patent Applications and US Patents resulting from U.S. Pat. No. 10,952,365 are also hereby incorporated in their entirety. According to some aspects, the predictive path lookahead system 200 disclosed herein may utilize the implement control system 216, which may include zero or more IPRs 218, zero or more IPNs 220, zero or more IPPs 222, and zero or more intelligent implement displays 224. Pertinent to the disclosed predictive path lookahead system, the implement control system of U.S. Pat. No. 10,952,365 may be adapted to detect, sense, monitor, and/or perform functionality related to generating a predicted lookahead trajectory and/or predicted future position of agricultural equipment as well as turning ON and/or turning OFF row units of an agricultural implement based on the predicted lookahead trajectory and/or predicted future position. The implement control system of U.S. Pat. No. 10,952,365 may also be adapted to detect, sense, monitor, and/or perform functionality related to displaying the predicted lookahead trajectory and/or predicted future position and alerting a user based on the predicted lookahead trajectory and/or predicted future position. The implement control system of U.S. Pat. No. 10,952,365 may also be adapted to detect, sense, monitor, and/or perform functionality related to engaging in auto-steering of the agricultural equipment. For example, the features and capabilities of the predictive path lookahead system 200 may be performed and carried out by the implement control system 216. As described herein, this includes but is not limited to the ability to accurately measure, monitor, gather, collect, and determine navigation factors associated with agricultural equipment, the ability to input those navigation factors into a motion model to analyze and process those navigation factors, the ability to use the navigation factors in conjunction with processed data from the motion model and data from the navigation orientation tool to generate a predicted lookahead trajectory and/or a predicted future position of the agricultural equipment, the ability to automatically turn OFF and/or turn ON row units of the agricultural equipment based on the predicted trajectory and/or future position, the ability to display the predicted lookahead trajectory and/or predicted future position to a user and alert the user based on the predicted lookahead trajectory and/or predicted future position, and the ability to engage in auto-steering of the agricultural equipment based on the predicted lookahead trajectory and/or predicted future position. One or more IPPs 222 may act as sensors to collect data related to these functions, and the one or more IPNs 220 and IPRs 218 may be used to control and perform certain functions. Further, control and performance of certain functions may depend on user input offered via the intelligent implement display 224. The intelligent implement display 224 may be configured to display information and/or data to a user regarding the sensing, monitoring, measuring, and/or functionality of the system. The intelligent implement display 224 may also be configured for a user to offer input.

For example, one or more IPPs can be used in conjunction with the one or more navigation sensors 204 when measuring, monitoring, gathering, collecting, and determining the one or more navigation factors 206. One or more IPNs can also work in conjunction with the motion model 208 to analyze, process, and apply an algorithm to the data input into the motion model 208. One or more IPNs can work in conjunction with the navigation orientation tool 202 to accurately input information from a map or automated guidance tool into the system 200 and to indicate which portions of an agricultural field are planted and which are unplanted. One or more IPNs can work in conjunction with the processing component 210 and the system 200 as a whole to generate a predicted lookahead trajectory and/or future position of the agricultural implement. One or more IPPs can work in conjunction with the display 212 to display the predicted lookahead trajectory and/or future position of an implement to a user and to send alerts to the user when the user is manually operating the agricultural equipment. Also, one or more IPPs can work in conjunction with the system 200 to engage in auto-steering of the agricultural vehicle and/or agricultural implement.

The intelligent implement display 224 may be a digital interface, a command-line interface, a graphical user interface (“GUI”), oral interface, virtual reality interface, or any other way a user can interact with a machine (user-machine interface). For example, the intelligent implement display 224 can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the display can then be sent to a microcontroller to control operational aspects of a device.

The intelligent implement display 224 can act as an input and/or output device. More particularly, the intelligent implement display 224 can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The intelligent implement display 224 also can be configured with a microcontroller to display conditions or data associated with the main device in real-time or substantially real-time.

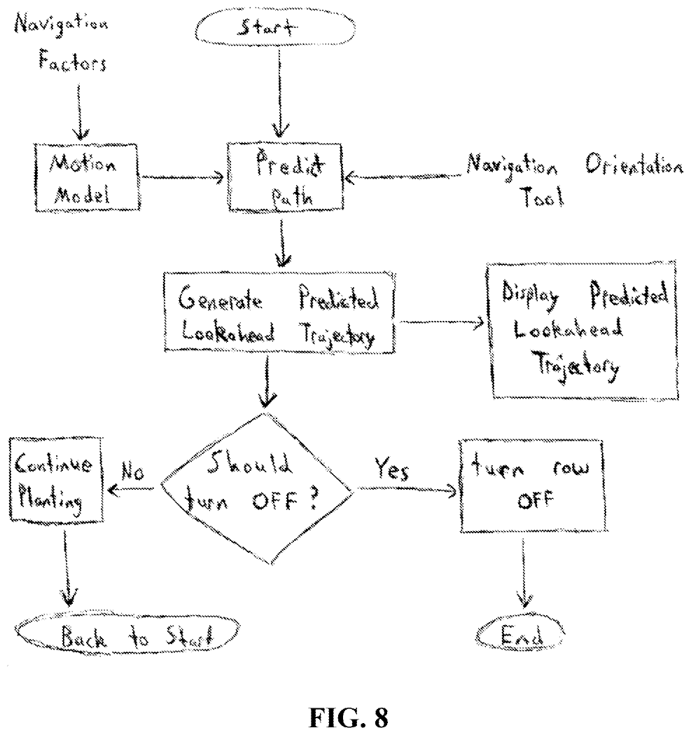

FIG. 8 shows a flow diagram of an exemplary embodiment of a predictive path lookahead method. The method includes the steps of monitoring, measuring, gathering, collecting, and/or determining navigation factors associated with an agricultural vehicle and/or agricultural implement and inputting the navigation factors into a motion model wherein the motion model analyzes, processes, organizes, and/or aggregates the factors as well as produces an output. The method further includes using the output of the motion model, which may include all the navigation factors, data from the navigation orientation tool, and any additional data input into the motion model and/or the system in general, such as physical data and/or environmental data, in order to complete the step of generating a predicted lookahead trajectory and/or predicted future position of the agricultural vehicle and/or agricultural implement. The method further includes the step of communicating the predicted lookahead trajectory and/or predicted future position to the system and/or to a display and displaying the predicted lookahead trajectory and/or predicted future position. The method further includes the step of communicating the predicted lookahead trajectory and/or predicted future position to the system and/or to the row unit(s) and using the predicted lookahead trajectory and/or predicted future position to pose the question to the system of whether a row unit should be turned OFF based on the predicted lookahead trajectory and/or predicted future position. If the row unit should not be turned OFF, the method further includes the step of continuing to plant and then the method repeats itself from the start. If the row unit should be turned OFF, the method further includes the step of turning OFF the row unit and then the method ends. The method is continuously implemented during operation of agricultural equipment as the agricultural equipment traverses an agricultural field. Thus, even if the method ends, it will continuously start over and be repeated. Similar to the question of whether a row unit should be turned OFF, the method may also include the step of posing a question to the system of whether a particular row unit should be turned ON based on the predicted lookahead trajectory and/or predicted future position. If a row unit should be turned ON, the method further includes the step of turning a row unit ON and continuing to plant. Then the method repeats itself. If a row unit should not be turned ON, the method further includes the step of leaving the row unit OFF. Then the method repeats itself.

As described above, navigation factors are associated with an agricultural vehicle and/or agricultural implement. The navigation factors may be gathered by one or more navigation sensors. The navigation factors may include but are not limited to GPS coordinates, speed, attitude, tilt, acceleration, heading, curvature, force, angular rate, orientation, trajectory, and/or steering angle. The navigation factors may then be input into the motion model. The motion model then analyzes, processes, organizes, and/or aggregates the navigation factors as well as any other factors input into the motion model. The motion model outputs a result that reflects the position of the agricultural vehicle and/or agricultural implement and the nature of its motion. The motion model and/or the system in general can apply an estimation and/or prediction algorithm to the navigation factors and other data input into the motion model.

As described above, the output of the motion model, data from the navigation orientation tool, and any other relevant data are combined to perform the step of generating a predicted lookahead trajectory and/or predicted future position. The step of generating a predicted lookahead trajectory and/or predicted future position can be accomplished by any type of processing unit and/or component as described above. Generation of the predicted lookahead trajectory and/or predicted future position can be accomplished by using an estimation and/or prediction algorithm. This may include any techniques and/or algorithms described above including but not limited to a Kalman filter and/or other types of algorithms, mathematical formulae and/or principles, artificial intelligence/machine learning, analysis of historical data, and the like.

The exemplary method depicted in FIG. 8 further includes the step of displaying the predicted lookahead trajectory and/or predicted future position. As described above, by displaying the predicted lookahead trajectory and/or predicted future position to a user when the user is manually operating the agricultural equipment, the user can adjust the steering so that the user follows the lookahead trajectory. Further, the system can alert the user when to turn OFF and/or turn ON a row unit of the agricultural implement to avoid overplanting or underplanting. The system can also indicate to the user when the user is deviating from the predicted trajectory and/or position and can alert the user to correct the user's steering and/or can offer steering suggestions to the user.

The exemplary method depicted in FIG. 8 also includes the step of posing the question to the system of whether a row unit should be turned OFF. This question is based on the predicted lookahead trajectory and/or predicted future position as well as information regarding which parts of an agricultural field have already been planted and which have not. For example, if the agricultural implement is predicted to traverse a specified area that is already planted, an area not to be planted, or the specified area is too close to an already-planted area to plant additional seed, the system will answer “yes” a row unit should be turned OFF. The method then will perform the step of automatically turning OFF the row unit at the moment the implement is predicted to traverse the specified area to avoid overplanting. The method will then end. On the other hand, if the agricultural implement is predicted to traverse a specified area that has not been planted and is far enough away from an already-planted area to safely plant additional seed, the system will answer “no” indicating that a row unit should not be turned OFF. The method then will perform the step of continuing to plant at the moment the implement is predicted to traverse the specified area to avoid underplanting. The method will then go back to the start. Similarly, if a row unit was already OFF, the system could recognize this and automatically turn the row unit ON when the implement is predicted to traverse an area that has not yet been planted. The method is adapted to continuously perform during operation of the associated agricultural equipment.

The method could include an additional step of allowing the system to engage in auto-steering of the agricultural vehicle and/or agricultural implement based on the predicted lookahead trajectory and/or predicted future position such that the agricultural vehicle and/or agricultural implement is being operated autonomously. The system can continuously monitor and determine the navigation factors associated with the agricultural vehicle and/or agricultural implement in conjunction with continuously monitoring the navigation orientation tool and output from the motion model to ensure that the agricultural vehicle and/or agricultural implement is following the predicted lookahead trajectory and/or predicted future position. The system can continuously correct the agricultural vehicle and/or agricultural implement via auto-steering should it deviate from the predicted lookahead trajectory and/or predicted future position.

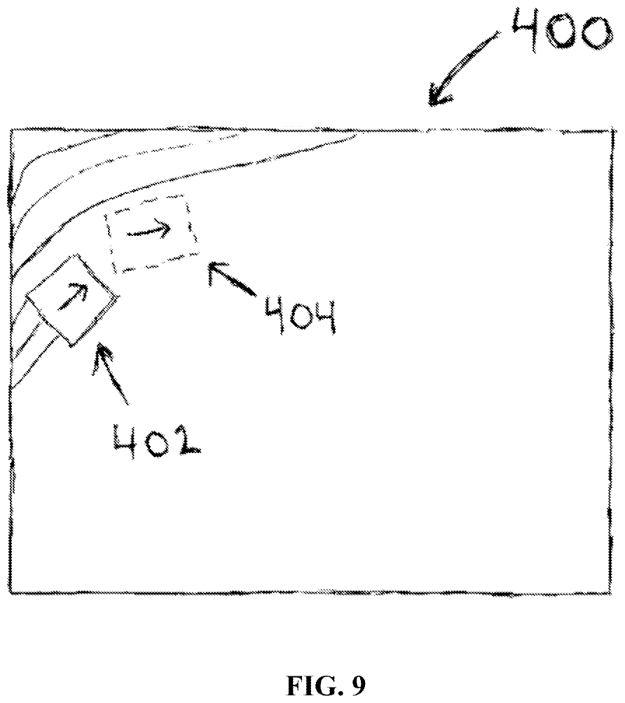

FIG. 9 shows an overhead illustration of an exemplary agricultural field 400. The exemplary illustration shows a current position of an agricultural vehicle and/or agricultural implement 402 and a predicted lookahead trajectory and/or predicted future position of the agricultural vehicle and/or agricultural implement 404. The exemplary illustration includes an area of the field 400 that has already been planted as illustrated by the solid lines. The exemplary illustration also includes an area of the field 400 that has not been planted as illustrated by a lack of lines. As can be seen in FIG. 9, the agricultural vehicle and/or agricultural implement encounters a curve wherein the predicted lookahead trajectory and/or predicted future position of the agricultural vehicle and/or agricultural implement 404 involves a different heading than that of the current agricultural vehicle and/or agricultural implement 402.

The predictive path lookahead system is adapted to automatically steer (auto-steer) around curvature to follow the predicted lookahead trajectory and/or predicted future position. The system is adapted to continuously monitor and determine the navigation factors associated with the agricultural vehicle and/or agricultural implement in conjunction with continuously monitoring the navigation orientation tool and output from the motion model to ensure that the agricultural vehicle and/or agricultural implement is following the predicted lookahead trajectory and/or predicted future position. Further, the system is adapted to continuously correct the agricultural vehicle and/or agricultural implement via auto-steering should it deviate from the predicted lookahead trajectory and/or predicted future position. While all navigation factors are relevant, some of the key factors when the system is engaging in auto-steering, especially when curvature is involved, are the GPS coordinates as well as input from the one or more cameras and LIDAR to sense what area of the field the agricultural vehicle and/or agricultural implement is in or near (planted versus unplanted) and/or if obstacles, objects, and/or curvature are in the vehicle's and/or implement's path. For example, in the exemplary depiction of FIG. 9, GPS coordinates used in conjunction with the navigation orientation tool are helpful in auto-steering the agricultural vehicle and/or agricultural implement to follow the predicted lookahead trajectory and/or predicted future position. Also, in the exemplary depiction of FIG. 9, cameras and/or LIDAR are helpful to recognize and sense the curvature and ensure that the agricultural vehicle and/or agricultural implement is accounting for the curvature.

The system is able to turn OFF and/or turn ON individual row units depending on whether the agricultural equipment is predicted to encounter an area of the field 400 that has already been planted, or, alternatively, an area of the field that has not been planted to avoid both overplanting and underplanting.

While much of the above description was focused on planting and planters, the disclosed systems, methods, and apparatuses can be applied to any agricultural function and any agricultural implement including but not limited to spraying, fertilizing, tilling, plowing, and the like.

Therefore, as understood from the present disclosure, the predictive path lookahead system provided includes continuously monitoring, measuring, and determining a wide variety of navigation factors associated with the agricultural equipment. By continuously monitoring, measuring, and determining several navigation factors, the system can provide robust motion data to the motion model in order to accurately and precisely determine the position of the agricultural equipment and the nature of the motion of the agricultural equipment and to aid in generating the best possible predicted lookahead trajectory and/or predicted future position. Using a robust set of navigation factors and motion data also allows for generating accurate and effective predicted paths even in challenging circumstances such as non-linear paths that include curvature, hills and/or slopes, and the like.

Further, in addition to having the ability to automatically turn OFF and/or turn ON row units of an agricultural implement, the predictive path lookahead system provided includes a display that can convey to a user information regarding the predicted path lookahead system and when to turn OFF and/or turn ON row units of an agricultural implement. The system can also convey information to the user regarding steering adjustments in order to follow the predicted lookahead trajectory and/or predicted future position. Therefore, the predictive path lookahead system provided has the ability to operate automatically and also has the ability to allow a user to operate a vehicle and/or implement manually while still utilizing and enjoying the benefits of the system.

From the foregoing, it can be seen that the invention accomplishes at least all of the stated objectives.

1. A predictive path lookahead system for use with an agricultural implement comprising:
a plurality of row units;
a navigation orientation tool;
a navigation sensor to measure one or more navigation factors;
a motion model into which the one or more navigation factors can be input; and
a processing component to generate a predicted lookahead trajectory of the implement based on the navigation orientation tool and the motion model, said predicted lookahead trajectory being non-linear;
wherein the system is adapted to turn ON and/or turn OFF individual row units among the plurality of row units based on the predicted lookahead trajectory of the implement.

2. The system of claim 1, wherein the navigation sensor comprises a GPS sensor and/or GPS receiver, a speed sensor, an attitude sensor, a tilt sensor, an acceleration sensor, an inertial measurement unit (IMU), one or more cameras, and/or a steering angle sensor.

3. The system of claim 1, wherein the one or more navigation factors comprises GPS coordinates of the implement, speed of the implement, attitude of the implement, tilt of the implement, acceleration of the implement, heading of the implement, curvature, force, angular rate of the implement, orientation of the implement, trajectory of the implement, and/or steering angle of the implement.

4. The system of claim 3, wherein the navigation factors are continuously monitored.

5. The system of claim 1, further comprising a display in which the predicted lookahead trajectory of the implement can be displayed to a user.

6. The system of claim 1, wherein each individual row unit is automatically turned ON and/or OFF.

7. The system of claim 1, wherein the system alerts a user when to manually turn ON and/or turn OFF a row unit.

8. The system of claim 1, wherein the navigation orientation tool is a map of agricultural terrain and/or an automated guidance tool.

9. The system of claim 1, wherein the system is adapted to automatically steer the implement based on the predicted lookahead trajectory such that the implement can operate autonomously.

10. The system of claim 1, wherein the motion model processes the one or more navigation factors.

11. A method of predicting the future trajectory of an agricultural implement comprising:
determining one or more navigation factors related to the agricultural implement;
inputting the one or more navigation factors into a motion model;
generating a non-linear predicted lookahead trajectory of the implement via navigation orientation information and the motion model; and
turning ON and/or turning OFF a row unit of the implement based on the non-linear predicted lookahead trajectory of the implement.

12. The method of claim 11, wherein the one or more navigation factors comprise GPS coordinates of the implement, speed of the implement, attitude of the implement, tilt of the implement, acceleration of the implement, heading of the implement, curvature of the implement, force of the implement, angular rate of the implement, orientation of the implement, trajectory of the implement, and/or steering angle of the implement.

13. The method of claim 11, wherein the navigation orientation information is based on a map of agricultural terrain and/or an automated guidance tool.

14. The method of claim 11, further comprising displaying the non-linear predicted lookahead trajectory to a user.

15. The method of claim 11, wherein the row unit is turned ON and/or turned OFF automatically.

16. The method of claim 11, further comprising alerting a user when to manually turn ON and/or turn OFF the row unit.

17. The method of claim 11, wherein the one or more navigation factors are determined by a navigation sensor that comprises a GPS sensor and/or GPS receiver, a speed sensor, an attitude sensor, a tilt sensor, an acceleration sensor, an inertial measurement unit (IMU), one or more cameras, and/or a steering angle sensor.

18. The method of claim 11, wherein the one or more navigation factors related to the implement are continuously monitored.

19. The method of claim 11, wherein the non-linear predicted lookahead trajectory may be generated via a Kalman filter.

20. A predictive path lookahead system for use with an agricultural implement comprising:
a row unit;
a navigation orientation tool;
a navigation sensor to measure a navigation factor;
a motion model into which the navigation factor can be input; and
a processing component to generate a predicted future position of the implement based on the navigation orientation tool and the motion model;
wherein the system is adapted to turn ON and/or turn OFF the row unit based on the predicted future position of the implement.
